(19) United States
(12) Patent Application Publication
(10) Pub. No.: US 2003/0125181 A1
(43) Pub. Date: Jul. 3, 2003

(54) Folding structure of a flier

(76) Inventor: Ming-Ta Wei, Tai-Ping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/032,001

(22) Filed: Dec. 31, 2001

(51) Int. Cl. B31B 1/26

(52) U.S. Cl. 493/959; 493/405

(57) ABSTRACT

A folding structure of a flier in which the nose of the fuselage is many times folded and has heavier weight. After the nose, the wing section and the folding section of the fuselage are folded, both the nose and the wing section partially overlap the folding section, whereby the folding section and the wing section can be stretched to form a flow-guiding space. In flight, the flow-guiding space makes the air blow onto the bottom face of the wing section, whereby the fuselage has a better buoyant force and the flier can stay in the air longer.

### BACKGROUND OF THE INVENTION

The present invention is related to a folding structure of a flier in which the folding section and the wing section can be stretched to form a flow-guiding space, whereby the flier can stay in the air longer.

FIG. 8 shows a conventional flier having a fuselage 40, a port wing 50 and a starboard wing 60 which are respectively formed on two sides of the fuselage 40. A left tail fin 51 and a right tail fin 61 are respectively formed on left and right sides of the rear end of the fuselage 40. Such flier is made of paper sheet by folding without cutting. Therefore, the flier generally has a considerable weight. Moreover, the nose of the flier has insufficient weight so that when the flier is thrown out, the flier can hardly inertially fly and can only stay in the air in short time.

FIG. 9 shows another type of flier in which a weight 80 is additionally disposed at front end of the fuselage 70 for having better inertia when throwing out the flier. Under such circumstance, the weight of the fuselage 70 is concentrated on the nose 71 so that the flier 70 tends to fly down. Moreover, the wings 72 of such flier have stiff pattern and the air can hardly blow onto the bottom faces of the wings 72. Therefore, the fuselage 70 has poor buoyant force and can hardly stay in the air longer.

### SUMMARY OF THE INVENTION

It is therefore a primary object of the present invention to provide a folding structure of a flier in which the nose of the flier is many times folded and has a heavier weight. After folded, both the nose and the wing section partially overlap the folding section. The folding section and the wing section can be stretched open to form a flow-guiding space. In flight, the flow-guiding space makes the air blow onto the bottom face of the wing section, whereby the fuselage has a better buoyant force and the flier can stay in the air longer.

The present invention can be best understood through the following description and accompanying drawings wherein:

### BRIEF DESCRIPTION OF THE DRAWINGS

FIG. 1 is a stretched view of a first embodiment of the present invention;

FIG. 2 shows the present invention in a folded state;

FIG. 3 is a perspective view of the present invention after folded;

FIG. 4 shows the flow-guiding effect of the present invention;

FIG. 5 is a perspective view of a second embodiment of the present invention;

FIG. 6 is a perspective view of a third embodiment of the present invention;

FIG. 7 is a perspective view of a fourth embodiment of the present invention;

FIG. 8 is a perspective view of a conventional flier; and

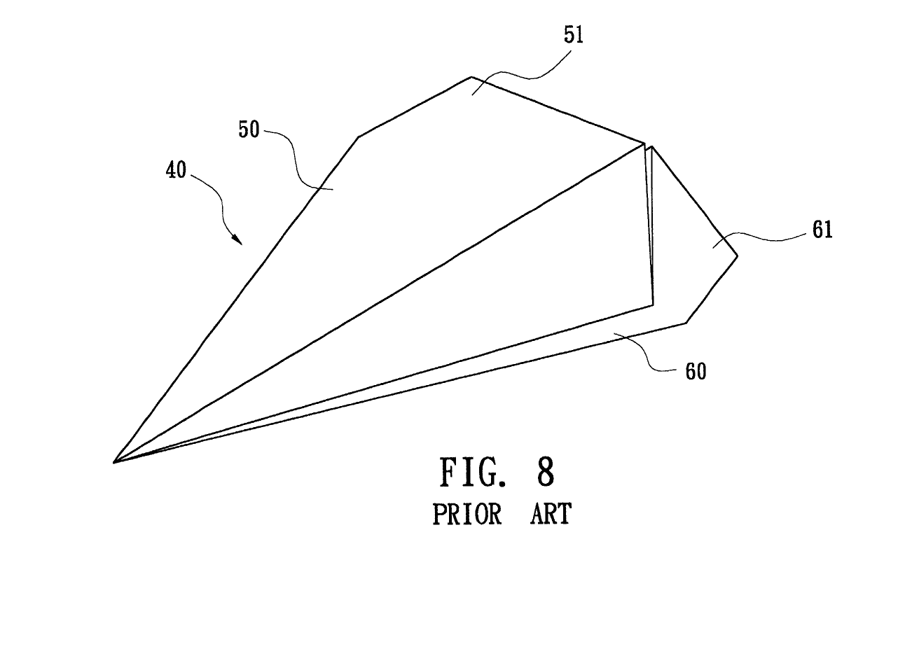

FIG. 9 is a perspective view of another type of conventional flier.

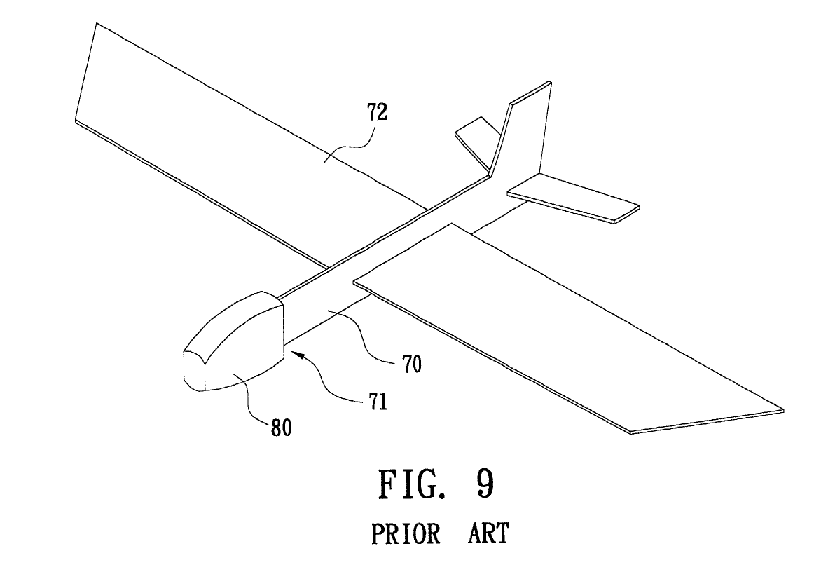

### DETAILED DESCRIPTION OF THE PREFERRED EMBODIMENTS

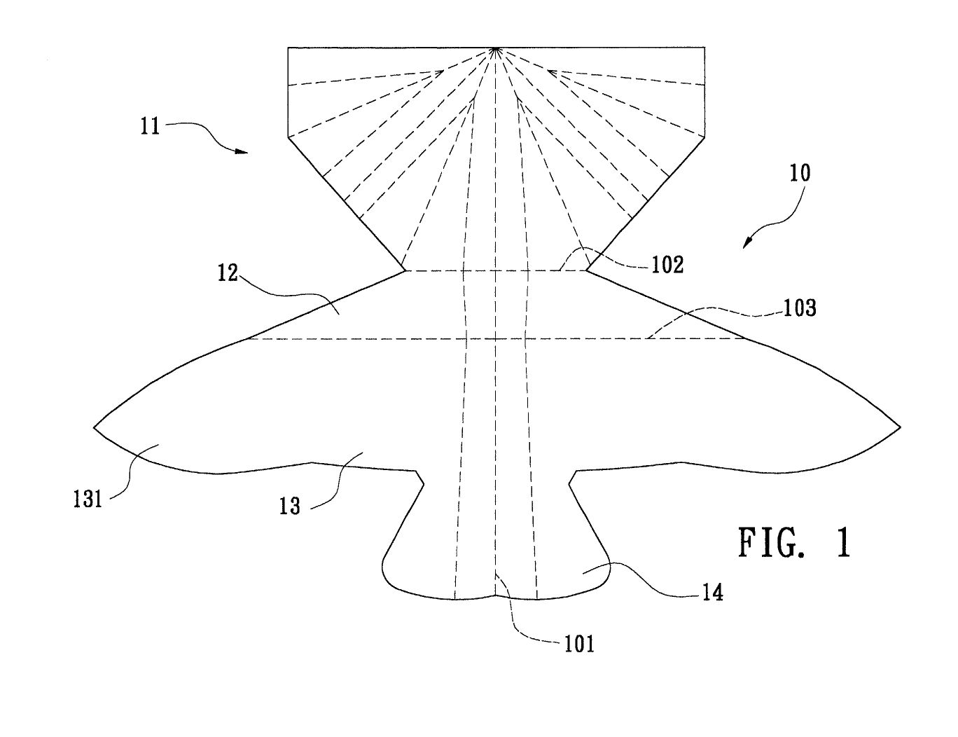

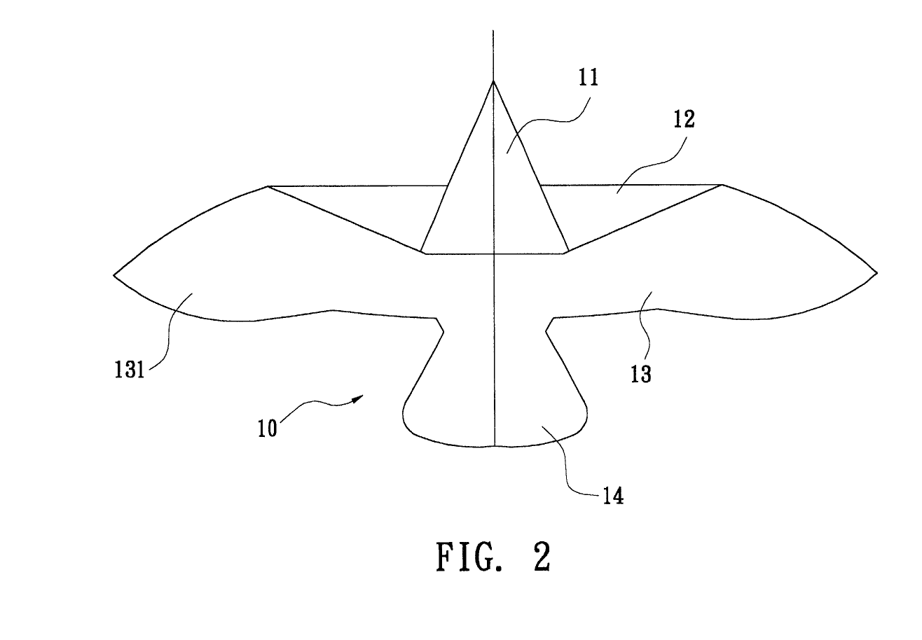

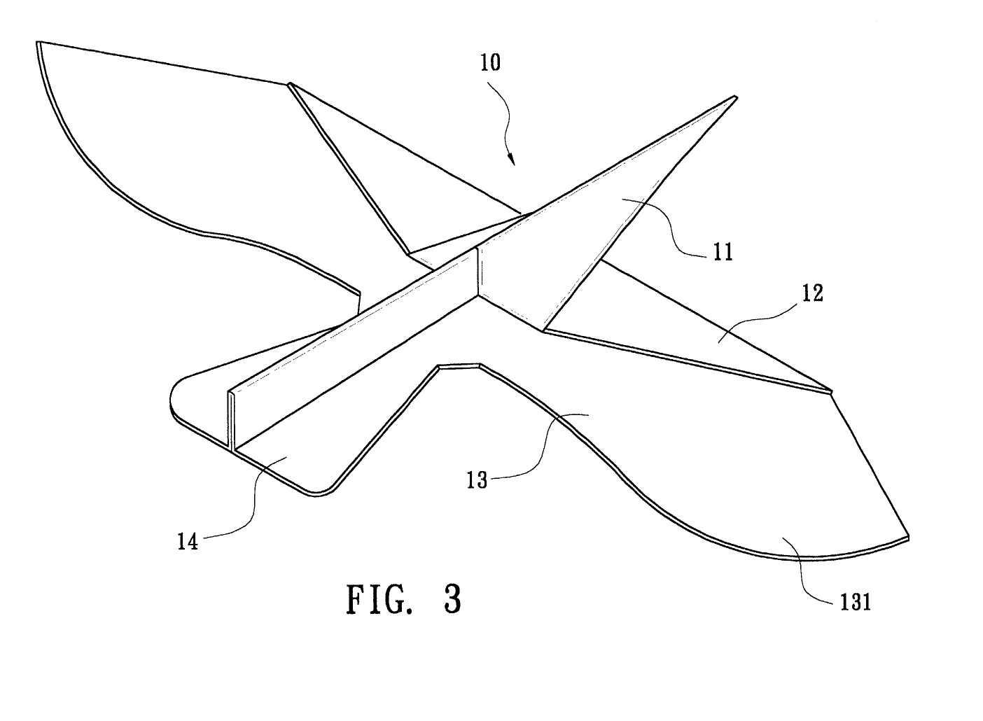

Please refer to FIGS. 1 to 3. According to a first embodiment, the folding structure of the flier of the present invention includes a fuselage 10 extending from front side to rear side. The fuselage 10 is integrally formed with a nose 11, a folding section 12, a wing section 13 and a tail 14. The center of the fuselage 10 is formed with a first folding line 101 which longitudinally extends between symmetrical left and right halves of the fuselage. The nose 11 is inward many times folded and has heavier weight. The nose 11 and the folding section 12 adjoin with each other along a second folding line 102. The wing section 13 and the folding section 12 adjoin with each other along a third folding line 103. After folded about the second folding line 102 and third folding line 103, both the nose 11 and the wing section 13 partially overlap the folding section 12. The rear edge of the folding section 12 is connected with the nose 11, while the front edge of the folding section 12 is connected with the wing section 13. The folding section 12 can be stretched from the wing section 13 to form a flow-guiding space H. The lateral sides of the wing section 13 which are not connected with the folding section 12 form two wings 131.

In use, a user can hold the middle of the fuselage 10 to throw out the flier. At this time, the fuselage 10 inertially flies forward. The front end of the fuselage 10 is the nose 11 which is many times folded and has a certain weight. The nose 11 is integrally folded and formed with the fuselage 10 so that it is unnecessary to add any weight onto the nose 11 as in the conventional flier.

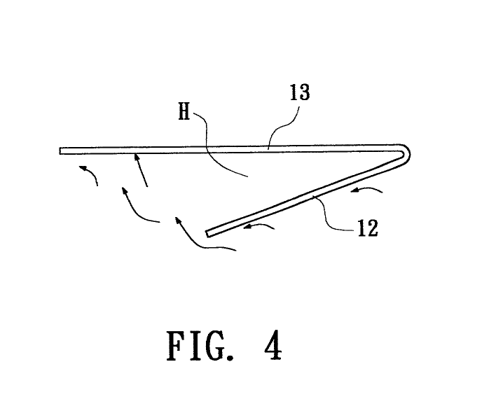

The folding section 12 is folded backward to the wing section 13 so as to make the gravity center of the fuselage 10 fall onto a one-third section of the wing section 13. Therefore, when the fuselage 10 flies, due to the weight of the nose 11 and the inertia of the throw, the flier can stably fly in a fixed direction. The top face of the wing section 13 suffers the stop of air to press the fuselage 10 backward so as to balance the front and rear sides of the fuselage 10. In addition, in flight, the wing section 13 makes the air flow through the flow-guiding space H under the wing section 13 and through the rear side of the wing section 13 to achieve a flow-guiding effect. This flow-guiding effect makes the air blow onto the bottom face of the wing section 13 as shown in FIG. 4. Therefore, the wing section 13 can have a better buoyant force and the flier of the present invention can stay in the air longer.

In addition, the folding section 12 is only partially connected with the wing section 13. The lateral sides of the wing section 13 which are not connected with the folding section 12 form two wings 131. When flying, the inner side of the wing section 13 adjacent to the fuselage 10 is able to bear greater flow-guiding effect. The wings 131 on outer sides of the wing section 13 have less flow-guiding effect, whereby the wing section 13 can have balanced flow-guiding effect to make the flight more stable.

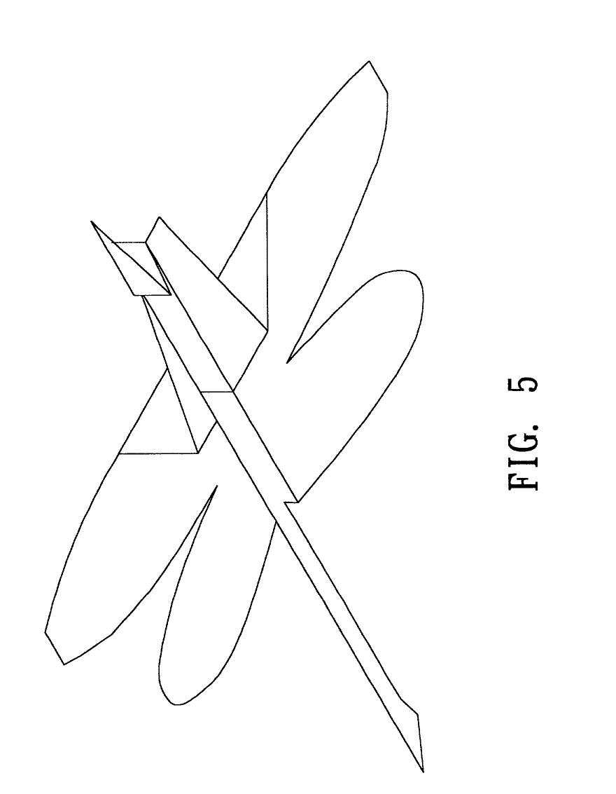

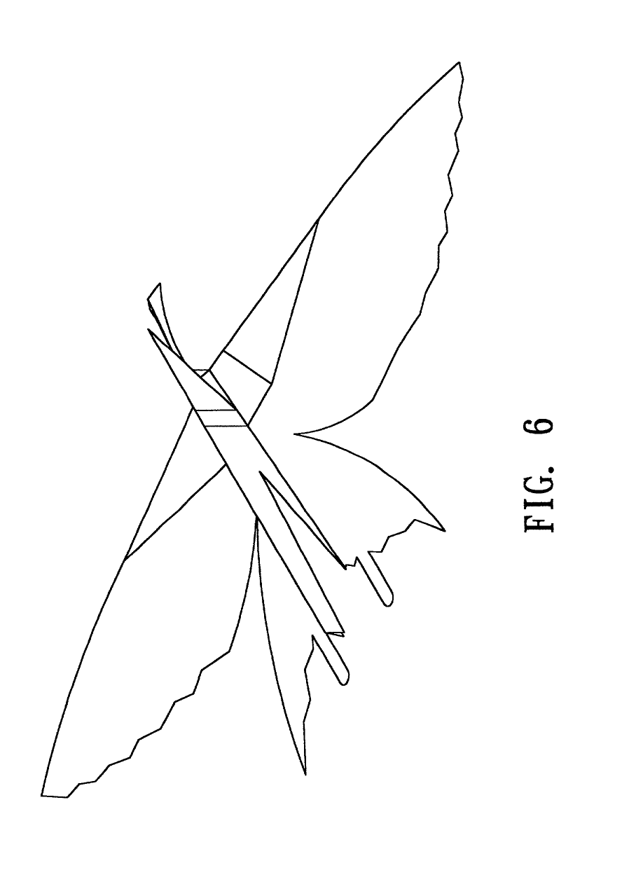

FIGS. 5 and 6 show a second and a third embodiments of the present invention, in which the fuselage 10 can be designed with a form of an insect such as a dragonfly and a butterfly. This can achieve the same effect as the above embodiment.

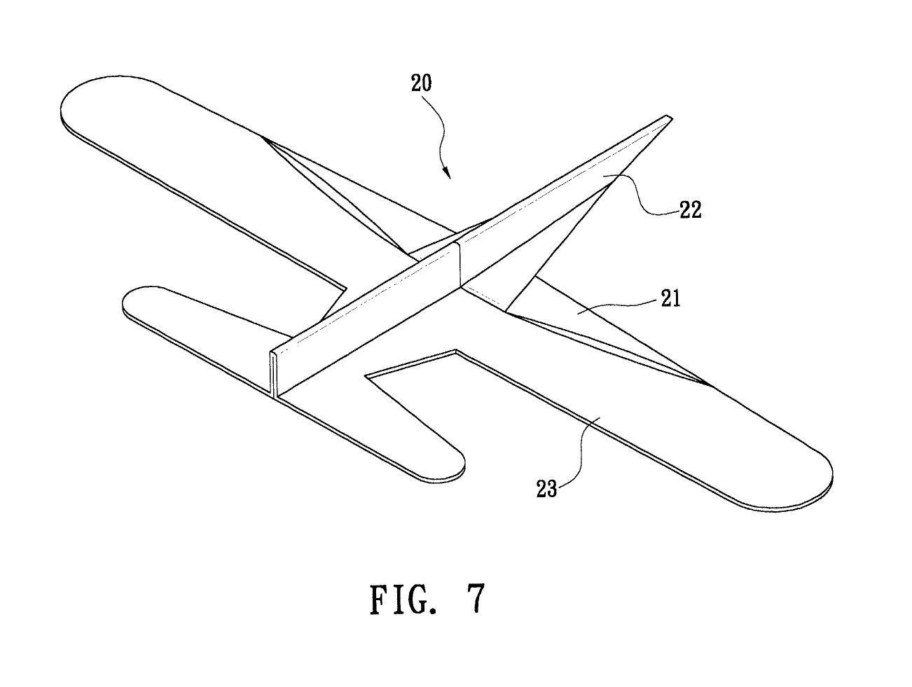

FIG. 7 shows a fourth embodiment of the present invention, in which the folding section 21 of the fuselage 20 has multiple fourth folding lines (not shown). After the nose 22, folding section 21 and wing section 23 are folded, the folding section 21 is formed with manifold flow-guiding wing sections. This can achieve the same effect as the above embodiment.

According to the above arrangement, the present invention has an advantage as follows:

The nose of the flier is many times folded and has a heavier weight. After folded, both the nose and the wing section partially overlap the folding section. The folding section and the wing section can be stretched open to form a flow-guiding space. In flight, the flow-guiding space makes the air blow onto the bottom face of the wing section, whereby the fuselage has a better buoyant force and the flier can stay in the air longer.

The above embodiments are only used to illustrate the present invention, not intended to limit the scope thereof. Many modifications of the above embodiments can be made without departing from the spirit of the present invention.

What is claimed is:

1. A folding structure of a flier comprising a stretched fuselage extending from front side to rear side, the fuselage integrally having a nose, a folding section adjoining with the nose, a wing section adjoining with the folding section and a tail adjoining with the wing section, a center of the fuselage being formed with a first folding line which longitudinally extends from the nose to the tail between symmetrical left and right halves of the fuselage, the nose and the folding section adjoining with each other along a second folding line, the wing section and the folding section adjoining with each other along a third folding line, a rear edge of the folding section being connected with the nose, whereby after folded about the second folding line and third folding line, both the nose and the wing section partially overlap the folding section, a front edge of the folding section being connected with the wing section, whereby the folding section and the wing section can be stretched to form a flow-guiding space, the nose being inward many times folded and having heavier weight.

2. The folding structure of a flier as claimed in claim 1, wherein after the nose, the folding section and the wing section are folded, the folding section is formed with single flow-guiding wing section.

3. The folding structure of a flier as claimed in claim 1, wherein after the nose, the folding section and the wing section are folded, the folding section is formed with manifold flow-guiding wing section.
